(19) United States
(12) Patent Application Publication
(10) Pub. No.: US 2019/0070562 A1
(43) Pub. Date: Mar. 7, 2019

(54) EXTERNAL-PRESSURE TYPE HOLLOW FIBER MEMBRANE MODULE

(71) Applicant: DAICEL CORPORATION, Osaka-shi, Osaka (JP)

(72) Inventors: Kazuhisa KUMAMI, Himeji-shi (JP); Yasunori IWAI, Himeji-shi (JP); Shigeyuki IKENAGA, Himeji-shi (JP)

(73) Assignee: DAICEL CORPORATION, Osaka-shi, Osaka (JP)

(21) Appl. No.: 16/084,673

(22) PCT Filed: Mar. 9, 2017
(86) PCT No.: PCT/JP2017/009355

§ 371 Date: Sep. 13, 2018

(30) Foreign Application Priority Data
Mar. 14, 2016 (JP) 2016-049398

(51) Int. Cl. B01D 63/04; B01D 63/02; B01D 65/08

(52) U.S. Cl. CPC B01D 63/043; B01D 63/024; B01D 2313/21; B01D 63/022; B01D 63/046; B01D 65/08

(57) ABSTRACT

An external-pressure type hollow fiber membrane module in which fouling is not likely to occur in a hollow fiber membrane at the time of filtering operation, and which exhibits excellent washability of the hollow fiber membrane is provided. The first end side and the second end side of a plurality of hollow fiber membrane bundles 60 are fixed with adhesive, together with an inner wall surface of the tubular housing 10 or an inner wall surface of the cap. The adhesive-fixed part of the first end side includes a plurality of raw water introduction holes 65 which are formed therethrough in a thickness direction. An external-pressure type hollow fiber membrane module in which the plurality of raw water introduction holes 65 include first group raw water introduction holes 66 formed at positions including central parts of the plurality of hollow fiber membrane bundles 60, respectively, and second group raw water introduction holes 67 formed between the plurality of hollow fiber membrane bundles 60 and between the plurality of hollow fiber membrane bundles 60 and the inner wall surface of the tubular housing 10.

### FIELD OF THE INVENTION

The present invention relates to an external-pressure type hollow fiber membrane module which is usable for water processing purposes in various fields.

### BACKGROUND OF THE INVENTION

When filtering operation is continued by using a hollow fiber membrane module in which a plurality of hollow fiber membranes are accommodated, fouling, which deteriorates filtering performance, may occur as a result of formation of an adherent layer on the membrane surface, clogging of the membrane, and so on. When such fouling occurs, the membrane is washed by performing air scrubbing washing, back-pressure washing, and so on to recover the filtering performance.

FIG. 6 in Patent Document 1 (Japanese Patent No. 4498373) shows a module for a rack-type filtering apparatus. One ends of multiple hollow fiber membranes 3a are integrated with an adhesive fixed layer 14 having a through-hole 14a. At the time of filtering operation, raw water is supplied to a supply-water inlet 2c to enter into a lower ring 13, and is thereafter guided to an outer peripheral surface of the hollow fiber membrane 3a through the through-hole 14a (Paragraph No. 0046). When gas bubbling of the hollow fiber membrane 3a is performed, gas is supplied from the lower ring 13 from the gas supply port and is passed through the through-hole 14a of the adhesive fixed part 14, thereby causing the hollow fiber membrane 3a to vibrate (Paragraph No. 0047). FIGS. 7 and 8 show a positional relationship between the hollow fiber membrane 3a and the through-hole 14a.

FIG. 1 of Patent Document 2 (Japanese Patent No. 3686225) shows a hollow fiber membrane module in which a flow regulation tube 6 is disposed near the center of a hollow fiber membrane bundle 1. At the time of filtering operation, liquid to be processed enters from a raw water inlet 7, passes through the outer periphery of the hollow fiber membrane bundle and the flow regulation tube 6, thereby being filtered by the hollow fiber membrane 1, and exits out of the hollow fiber membrane module through a filtered water outlet 8. At the time of air scrubbing, air supplied from an air introduction port 10 which also acts as a drain port is distributed by an air nozzle 5 to be released against the hollow fiber membrane 1 (Paragraph No. 0011).

FIG. 1 of Patent Document 3 (Japanese Patent No. 5708619) shows a hollow fiber membrane module 1. At each end of a hollow fiber membrane 4, a potting part 5, 5′ is provided and a conical through-hole 6, which serves as a flow outlet of the liquid supplied from outside the module, is formed in a middle portion of the potting part 5 (Paragraph Nos. 0011 and 0013). It is described that as a result of having the conical through-hole 6, all the accommodated hollow fiber membranes can be effectively utilized regardless of the position of the hollow fiber membrane (Paragraph No. 0014).

FIG. 1 of Patent Document 4 (Japanese Patent No. 3694535) shows a hollow fiber membrane module. In the hollow fiber membrane module, hollow fiber membranes 2, a plurality of which are collected in a module case 1, and an introduction tube 4, which has a water introduction hole 5 and is inserted into the hollow fiber membrane 2, are accommodated. The introduction tube 4 is in communication with a raw water passage, with one end of which being fixed with a resin fixed part 3 and the other end of which being opened (Paragraph No. 0018). At the time of filtering operation, the raw water, which is introduced from the raw water passage, is supplied to an inner peripheral surface of a hollow fiber membrane bundle from the water introduction hole 5 of the water introduction tube 4 at the same time when it is supplied to an outer peripheral surface of the hollow fiber membrane bundle. It is described that since the raw water enters from both surfaces of the outer peripheral surface and the inner peripheral surface of the hollow fiber membrane bundle, a contact area between the hollow fiber membrane and the raw water increases, thus making it possible to reduce deterioration of filtration efficiency of the hollow fiber membrane due to deposit coating of filtered substance (Paragraph No. 0019).

### SUMMARY OF THE INVENTION

It is an objective of the present invention to provide an external-pressure type hollow fiber membrane module in which fouling is not likely to occur in a hollow fiber membrane at the time of filtering operation, and the hollow fiber membrane exhibits excellent washability.

The present invention provides an external-pressure type hollow fiber membrane module including: a tubular housing to which a cap with a liquid access port including a raw water supply port and a cap with a liquid access port including a permeated water outlet is fixed at openings at respective ends; and a plurality of hollow fiber membrane bundles accommodated in the tubular housing, wherein

the plurality of hollow fiber membrane bundles are configured such that

a first end surface thereof on a raw water supply port side is fixed with adhesive, together with an inner wall surface of the tubular housing or an inner wall surface of the cap, in a state in which the hollow fiber membrane bundles on the first end surface side are closed,

a second end surface side thereof on a permeated water outlet side axially opposite to the first end surface side is fixed with adhesive, together with an inner wall surface of the tubular housing or an inner wall surface of the cap, in a state in which the hollow fiber membrane bundles on the second end surface side are open, and

an adhesive-fixed part on the first end surface side includes a plurality of raw water introduction holes formed therethrough in a thickness direction, and wherein

the plurality of raw water introduction holes include:

first group raw water introduction holes formed at positions including central parts of the plurality of hollow fiber membrane bundles, respectively, and second group raw water introduction holes formed between the plurality of hollow fiber membrane bundles and between the plurality of hollow fiber membrane bundles and the inner wall surface of the tubular housing.

Since raw water is supplied to both the inside and the outside of the hollow membrane bundle, the external-pressure type hollow fiber membrane module of the present invention exhibits less variation in the flow of raw water. Since, for this reason, a deposit layer which originates from a suspended substance becomes not likely to be formed and also clogging becomes not likely to occur on the hollow fiber membrane surface, fouling becomes not likely to occur as well.

### BRIEF DESCRIPTION OF DRAWINGS

FIG. 1 is a longitudinal sectional view of an external-pressure type hollow fiber membrane module of the present invention.

FIG. 2 is partially enlarged views of (a) a first end side of FIG. 1, and (b) a second end side of FIG. 1.

FIG. 3 is a widthwise sectional view of an adhesive-fixed part on the first end side of the hollow fiber membrane module shown in FIG. 1.

FIG. 4 is an enlarged view of one bundle of the hollow fiber membrane bundles in FIG. 3.

### EMBODIMENTS OF THE INVENTION

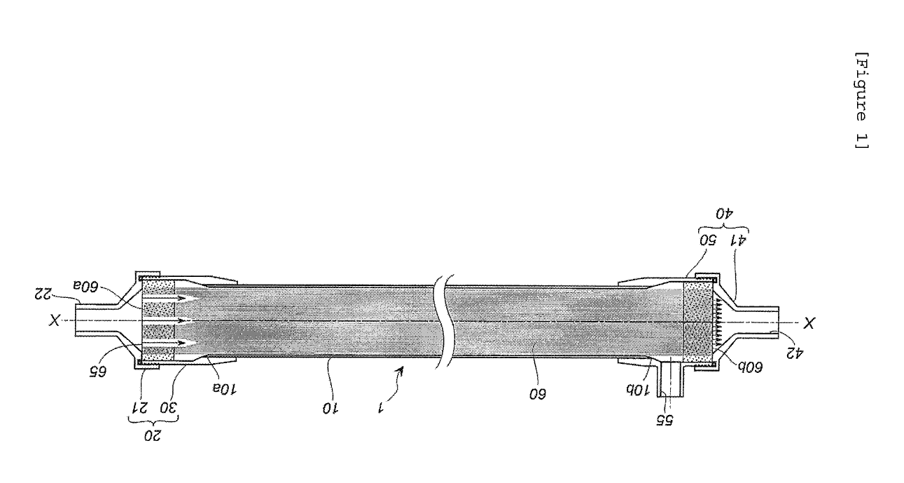

In the external-pressure type hollow fiber membrane module 1 shown in FIG. 1, a plurality of hollow fiber membrane bundles 60 are accommodated in a tubular housing 10. The widthwise sectional shape of the tubular housing 10 may be circular, polygonal (preferably polygonal close to circular), and so on. The material of the tubular housing 10 may be metal, synthetic resin, and so on. The size of the tubular housing 10 (the quantity of its internal volume) can be determined depending on a total number of the hollow fiber membrane bundles which are used in accordance with the filtering performance.

On the first end 10a side of the tubular housing 10, a first-end side cap 20 is attached from the outside. The first-end side cap 20 is preferably made of the same material as that of the tubular housing 10.

The first-end side cap 20 are made up of a combination of a first a-cap part 21 having a raw water supply port (which also serves as a back-pressure washing water outlet) 22, and a second a-cap part 30. The first a-cap part 21 and the second a-cap part 30 may be integrated into a single body.

The first a-cap part 21 includes a raw water supply port (first a-small-diameter part) 22, and a first a-annular large-diameter part 23 which has a larger outer diameter than that of the raw water supply port 22 and is located on the opposite side in the X-axis direction of the raw water supply port 22, and further includes a first a-annular inclined surface part 24 and a first a-annular flat surface part 25 in that order from the raw water supply port 22 side to the first a-annular large-diameter part 23 side between the raw water supply port 22 and the first a-annular large-diameter part 23. The size of the first a-annular large-diameter part 23 is about the same as the outer diameter of the second a-cap part 30 (second a-thin-wall part 33). The inner surface of the first a-annular large-diameter part 23 includes an inner thread part. An annular groove is formed in an annular end surface inside the first a-annular flat surface part 25, and an O-ring 26 is fitted thereinto.

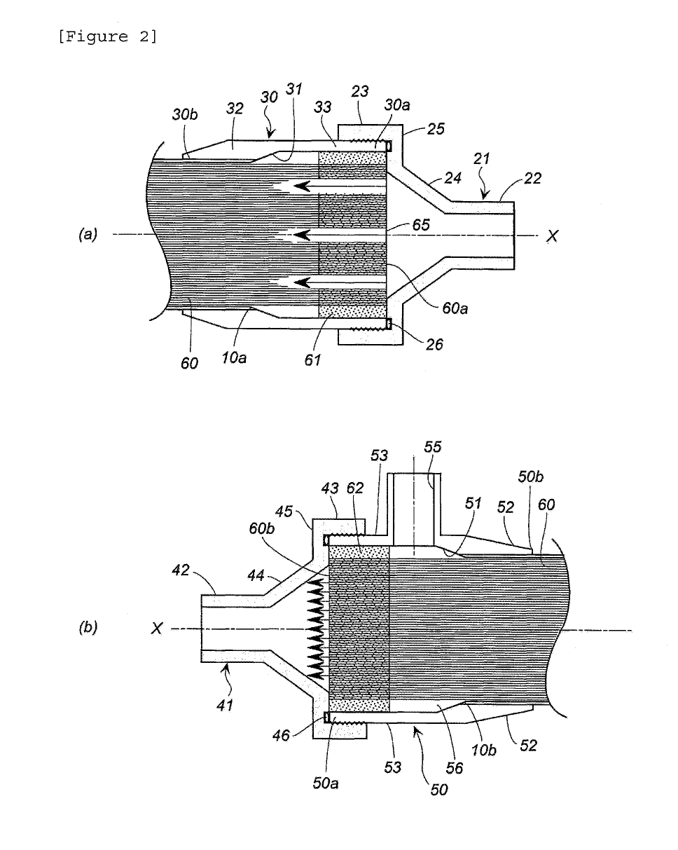

The second a-cap part 30 has a tubular shape, whose second end 30b side is sized so as to be fitted onto the first end 10a side of the tubular housing 10 from the outside, and whose first end 30a side, which is on the opposite side, is sized so as to be fitted onto the first end surface 60a (first fixed layer 61) of the hollow fiber membrane bundle 60 from the outside. The second a-cap part 30 has a second a-annular step surface 31 on the inner surface side, which includes a second a-thick-wall part 32 located from the second a-annular step surface 31 to the second end 30b side and having a small inner diameter, and a second a-thin-wall part 33 located from the second a-annular step surface 31 to the first end 30a side and having a large inner diameter (thickness of the second a-thick-wall part 32>thickness of the second a-thin-wall part 33). Although the outer surface of the second a-thick-wall part 32 is shown to be an inclined surface in FIGS. 1 and 2, it may be a flat surface. The outer surface of the second a-thin-wall part 33 includes an outer thread part which can be screwed with the inner thread part of the first a-annular large-diameter part 23.

The second a-cap part 30 may be integrally formed with the first end 10a side of the tubular housing 10. When the second a-cap part 30 and the tubular housing 10 are integrally formed, the first a-cap part 21 will be a separate member.

The second a-cap part 30 is connected in a state in which the second end 30b side is fitted onto the first end 10a side of the tubular housing 10 from the outside, and the first end 30a side is fitted onto the first end surface 60a (first fixed layer 61) of the hollow fiber membrane bundle 60 from the outside. It is possible to apply a method such as screwing, bonding with adhesive, and welding to the connection between the first end 10a of the tubular housing 10 and the tubular second a-cap part 30 according to the material of each member.

The first a-cap part 21 and the second a-cap part 30 are fixedly connected by screwing the inner thread part of the annular large-diameter part 23 of the first a-cap part 21 and the outer thread part of the second a-thin-wall part 33 of the second a-cap part 30.

A second-end side cap 40 is attached to the second end 10b side of the tubular housing 10 from the outside. The second-end side cap 40 is preferably made of the same material as that of the tubular housing 10.

The second-end side cap 40 is made up of a combination of a first b-cap part 41 having a permeated water outlet 42, and a second b-cap part 50 having a concentrated water outlet 55. The first b-cap part 41 and the second b-cap part 50 may be a single integrated body.

The first b-cap part 41 includes the permeated water outlet (first b-small-diameter part) 42, and a first b-annular large-diameter part 43 which has a larger outer diameter than that of the permeated water outlet 42 and is located on the opposite side in the X-axis direction of the permeated water outlet 42, and further includes a first b-annular inclined surface part 44 and a first b-annular flat surface part 45 in that order from the permeated water outlet 42 side to the first b-annular large-diameter part 43 side between the permeated water outlet (first b-small-diameter part) 42 and the second b-annular large-diameter part 43. The size of the first b-annular large-diameter part 43 is about the same as the outer diameter of the second b-cap part 50 (second b-thin-wall part 53). The inner surface of the first b-annular large-diameter part 43 includes an inner thread part. An annular groove is formed in the annular end surface inside the first b-annular flat surface part 45, and an O-ring 46 is fitted thereinto.

The second b-cap part 50 has a tubular shape whose second end 50b side is sized so as to be fitted onto the second end 10b side of the tubular housing 10 from the outside, and whose first end 50a on the opposite side is sized so as to be fitted onto the second end surface 60b (second fixed layer 62) of the hollow fiber membrane bundle 60 from the outside. The second b-cap part 50 includes a second b-annular step surface 51 on the inner surface side, and includes a second b-thick-wall part 52 of a small inner diameter from the second b-annular step surface 51 to the second end 50b side, and a second b-thin-wall part 53 of a large inner diameter from the second b-annular step surface 51 to the first b-cap part 41 side (thickness of the second b-thick-wall part 52>thickness of the second b-thin-wall part 53). Although the outer surface of the second b-thick-wall part 52 is shown as an inclined surface in FIGS. 1 and 2, it may be a flat surface. The outer surface of the second b-thin-wall part 53 has an outer thread part which can be screwed with the inner thread part of the first b-annular large-diameter part 43.

The second b-cap part 50 of the second-end side cap 40 may be integrally formed with the second end 10b side of the tubular housing 10. When the second b-cap part 50 and the tubular housing 10 are integrally formed, the first b-cap part 41 will be a separated member.

The second b-cap part 50 is connected in a state in which the second end 50b side is fitted onto the second end 10b side of the tubular housing 10 from the outside, and the first end 50a side is fitted onto the second end surface 60b (second fixed layer 62) of the hollow fiber membrane bundle 60 from the outside. It is possible to apply a method such as screwing, bonding with adhesive, and welding to the connection between the second end 10b of the tubular housing 10 and tubular second b-cap part 50 in accordance with the material of each member.

The first b-cap part 41 and the second b-cap part 50 are fixedly connected by screwing the inner thread part of the first b-annular large-diameter part 43 of the first b-cap part 41 with the outer thread part of the second b-thin-wall part 53 of the second b-cap part 50.

Each of the plurality of hollow fiber membrane bundles 60 is made by bundling several hundreds to several thousands of known hollow fiber membranes. As the hollow fiber membrane, a hydrophilic membrane (cellulosic membrane such as cellulose acetate membrane) or a hydrophobic membrane, which is publicly known and has an outer diameter of 1 to 3 mm, and more preferably 1.3 to 1.6 mm, can be used. To achieve the objective of the present invention, it is preferable to use a hydrophilic membrane which is not likely to cause fouling, and more preferably to use a cellulosic ester membrane such as cellulose acetate membrane.

The plurality of hollow fiber membrane bundles 60 on the first end surface 60a side, which is on the first end 10a side (first-end side cap 20 side) of the tubular housing 10, are fixed in a state of being integrated with the inner wall surface of the first-end side cap 20 (second a-cap part 30) with a known adhesive (potting agent) (first fixed layer 61). The plurality of hollow fiber membrane bundles 60 on the second end surface 60b side, which is on the second end 10b side (second-end side cap 40 side) of the tubular housing 10, are fixed in a state of being integrated with the inner wall surface of the second-end side cap 40 (second b-cap part 50) with a known adhesive (potting agent) (second fixed layer 62). As the known adhesive (potting agent), one made of urethane resin, epoxy resin, and so on described in Paragraph No. 0027 of Patent Document 1 can be used.

The plurality of hollow fiber membrane bundles 60 on the first end surface 60a side are closed with an adhesive and are not open. The length of longitudinal X-axis direction of the first fixed layer 61 is about the same as the length of longitudinal X-axis direction of the second fixed layer 62. The plurality of hollow fiber membrane bundles 60 on the second end surface 60b side are not closed with an adhesive, and are open. The length in longitudinal X-axis direction of the second fixed layer 62 is within a range from the second end surface 60b of the hollow fiber membrane bundles 60 to a position which is not in contact with a concentrated water outlet 55.

The second b-cap part 50 of the second-end side cap 40 includes a second b-thick-wall part 52, second b-annular step surface 51, and a second b-thin-wall part 53, and a concentrated water outlet 55 is formed between the second b-annular step surface 51 and the second b-thin-wall part 53. For this reason, an annular space 56 having a space corresponding to the difference between the thicknesses of the second b-thick-wall part (small inner diameter) 52 and the second b-thin-wall part (large inner diameter) 53 is formed between the concentrated water outlet 55 and the hollow fiber membrane bundle 60 opposite to the concentrated water outlet 55. Since the concentrated water outlet 55 is opposed to the annular space 56, discharging of the concentrated water is smoothly performed.

The first fixed layer 61 has a plurality of raw water introduction holes 65 which are formed therethrough in the thickness direction. The plurality of raw water introduction holes 65 are formed to penetrate the first fixed layer 61, and may reach interior of the hollow fiber membrane bundle 60 in which a tip end of the introduction hole is not fixed with an adhesive. The plurality of raw water introduction holes 65 include first group raw water introduction holes 66 which are formed at positions including central parts of the plurality of hollow fiber membrane bundles 60, respectively, and second group raw water introduction holes 67 which are formed at positions not to oppose the plurality of hollow fiber membrane bundles 60 in the length direction. The number of the first group raw water introduction holes 66 is the same as that of the hollow fiber membrane bundles 60. The second fixed layer 62 does not include the above described raw water introduction holes 65.

The outer diameter (diameter) of the hollow fiber membrane bundle 60 is preferably 30 to 70 mm, and more preferably 40 to 60 mm. The thickness of the hollow fiber membrane bundle 60 (distance from the inner peripheral surface of the first group raw water introduction holes 66 to the outer peripheral surface of the hollow fiber membrane bundle 60) (t1 in FIG. 4) is preferably 12 to 30 mm, and more preferably 15 to 25 mm.

An opening diameter of the first group raw water introduction holes 66 is, although not specifically limited, preferably 20 to 40% of the diameter of the hollow fiber membrane bundle 60. The number of the second group raw water introduction holes 67 is, although not specifically limited, preferably the same as or more than the number of the first group raw water introduction holes 66. An opening diameter of the second group raw water introduction holes 67 is not specifically limited.

While a plurality of hollow fiber membrane bundles 60 are accommodated in the tubular housing 10, it is preferable that three or more bundles of the hollow fiber membranes 60 are accommodated. When three or more bundles of the hollow fiber membrane bundles 60 are accommodated, it is preferable that they are arranged in line symmetry with respect to a straight line passing through a center of a radial cross section of the first fixed layer 61 when viewed from the first end surface 60a side.

While a plurality of hollow fiber membrane bundles 60 are accommodated in the tubular housing 10, it is preferable that four or more bundles of the hollow fiber membranes 60 are accommodated. When four or more bundles of hollow fiber membrane bundles 60 are accommodated, they may not only be arranged in line symmetry as described above, but also arranged in point symmetry with respect to the center of the radial cross section of the first fixed layer 61 when viewed from the first end surface 60a side.

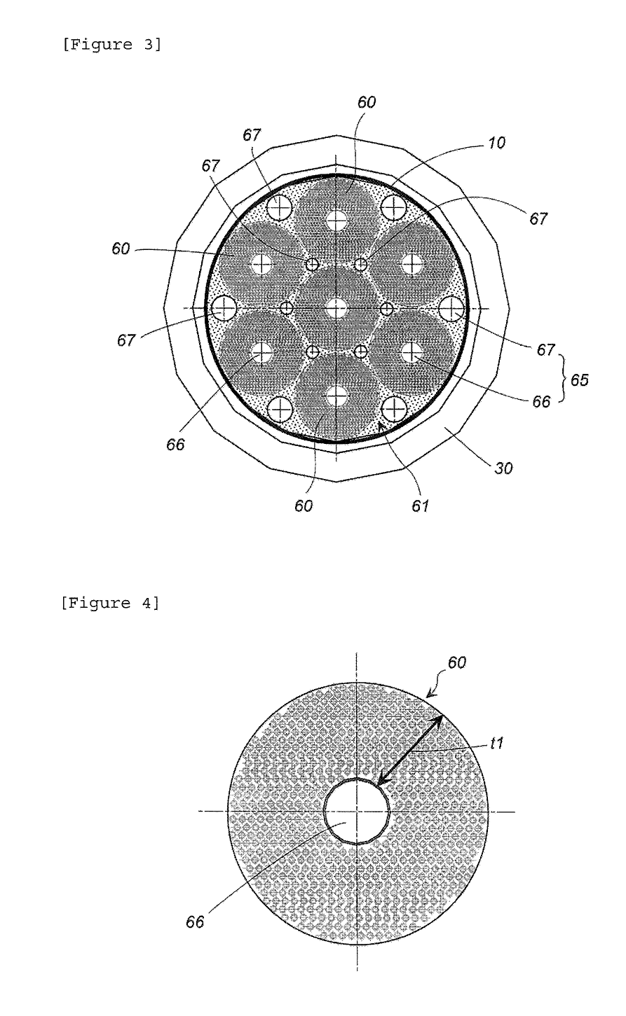

When an odd number equal to or more than five bundles of the hollow fiber membrane bundles 60 are annularly disposed, they will show line symmetry, but not point symmetry. However, as shown in FIG. 3, even when an odd number equal to or more than five bundles are accommodated, it is possible to make them show line symmetry and also point symmetry by arranging one bundle at the center, and annularly arranging remaining even number of bundles in the surrounding thereof. When a plurality of bundles of the hollow fiber membrane bundles 60 are accommodated, it is preferable that all the membrane bundles except a central hollow fiber membrane bundle which is arranged at a center of radial cross section of the fixed part with the above described adhesive have the same size (outer diameter and thickness t1) when viewed from the first end surface side; however, a variance of about ±5% may be permitted.

The proportion (A2/A1×100) of a total opening area (A2) of the first group raw water introduction holes 66 and the second group raw water introduction holes 67 within a radial sectional area (A1) of the first fixed layer 61 on the first end surface 60a side is preferably 5 to 20%, and more preferably 10 to 15% to achieve the objective of the present invention.

A ratio (A3/A4) of an opening area (A3) of the first group raw water introduction holes 66 and an opening area (A4) of the second group raw water introduction holes 67 is preferably 0.4 to 0.6, and more preferably 0.5 to 0.56 to achieve the objective of the present invention.

The hollow fiber membrane module 1 of the present invention may use as needed a perforated tube and a net-like pipe for introducing raw water, a partition plate for performing internal layout, a rod-like body (preferably made of synthetic resin) for reinforcement, and so on.

A hollow fiber membrane module 1 including a first fixed layer 61 which has a plurality of raw water introduction holes 65 (first group raw water introduction holes 66 and second group raw water introduction holes 67), and a second fixed layer 62 which does not have the plurality of raw water introduction holes 65 can be produced by the following method.

First, as a potting container, a first container which is made up of a bottom face and a peripheral wall part, and in which a plurality of rod-like formed bodies are vertically provided so as to be spaced apart from each other, and a second container which is configured in the same way as in the first container excepting that the rod-like formed bodies are absent are prepared. The number, forming position, outer diameter, and length of the rod-like formed bodies correspond to the number, forming position, inner diameter, and depth of the plurality of raw water introduction holes 65. The length of the rod-like formed body is about the same as, or larger than that of the raw water introduction hole 65.

Next, for the first end 10a and the second end 10b of the tubular housing 10, a required number of hollow fiber membrane bundles 60 are disposed within a structure connecting the second a-cap part 30 of the first-end side cap 20 and the second b-cap part 50 of the second-end side cap 40. The length of the hollow fiber membrane bundle 60 is adjusted by taking into consideration of a cutting step which is a subsequent step.

Next, the first container is attached to the second a-cap part 30 side of the first-end side cap 20, and the second container is attached to the second b-cap part 50 side of the second-end side cap 40. When the first container is attached, the rod-like formed bodies located at the bottom of the first container is in a state of being inserted into positions corresponding to the first group raw water introduction holes 66 and the second group raw water introduction holes 67 in FIG. 3.

Next, an adhesive (potting agent) is poured into the first container and the second container by a bonding method including a known centrifugation bonding method, and is thereafter cured. For the above described known bonding method, the centrifugation bonding method and static bonding method which are described in Paragraph No. 21 of Patent Document 1 and Paragraph No. 11 of Patent Document 2, and the multi-step potting method described in Paragraph No. 11 of Patent Document 3 can be applied.

Next, when the first container and the second container are detached, the second a-cap part 30 side of the first-end side cap 20 will be in a state shown in FIG. 3, in which the first end surface 60a of the hollow fiber membrane bundle 60 is closed with the adhesive. Since the second end surface 60b of the hollow fiber membrane bundle 60 on the second b-cap part 50 side of the second-end side cap 40 is closed with the adhesive, it is cut by a required length to be open. In this way, the first fixed layer 61 and the second fixed layer 62 are formed.

Next, it is possible to obtain the hollow fiber membrane module 1 by connecting the first a-cap part 21 to the second a-cap part 30 of the first-end side cap 20, and connecting the first b-cap part 41 to the second b-cap part 50 of the second-end side cap 40.

The hollow fiber membrane module 1 of the present invention preferably has a membrane area (effective membrane area) of not less than 10 m², and more preferably has a membrane area (effective membrane area) of 30 to 45 m².

Next, a filtering operation method of the hollow fiber membrane module 1 of the present invention will be described. The hollow fiber membrane module 1 is in a state in which the first end 10a side of the tubular housing 10 is as shown in FIG. 3. While the hollow fiber membrane module 1 can be used either in a vertical type or in a transverse type, it is considered that even when used in the vertical type, a middle part of the hollow fiber membrane bundle 60 which is apart from the first fixed layer 61 and the second fixed layer 62 will be deflected, resulting in that adjacent hollow fiber membrane bundles 60 are in contact with each other. Even in such a case, since the first group raw water introduction holes 66 and the second group raw water introduction holes 67 are formed in the first fixed layer 61, the raw water is more likely to flow in the extension of longitudinal X-direction of the first group raw water introduction holes 66 and the second group raw water introduction holes 67.

When raw water is supplied from the raw water supply port 22 of the hollow fiber membrane module 1, it enters into a space between the first a-cap part 21 of the first-end side cap 20 and the first fixed layer 61. Thereafter, the raw water is supplied to a central portion of the hollow fiber membrane bundle 60 through the first group raw water introduction holes 66 shown in FIG. 3, and also supplied to the surrounding of the hollow fiber membrane bundle 60 through the second group raw water introduction holes 67.

Thereafter, after being filtered by external pressure from the outside to the inside of the hollow fiber membrane, the raw water is discharged from a permeated water outlet 42 through the interior of the hollow fiber membrane. The concentrated water is discharged from the concentrated water outlet 55 through the annular space 56. Also, the operation may be performed with the concentrated water outlet 55 being closed, and in such a case, it becomes dead-end filtering operation.

In this way, deviation of raw water flow is reduced during filtering operation as a result of the raw water being filtered while being supplied to the central part and the surrounding of the hollow fiber membrane bundle 60. Thus, on the surface of the hollow fiber membrane, a deposit layer originated from suspended substance is not likely to be formed, clogging is not likely to occur, and fouling is not likely to occur as well.

Although, backwashing and gas bubbling were performed in every 28.5 minutes of the filtering operation (Paragraph No. 0056) in Example 1 of the invention of Patent Document 1, and air scrubbing washing was performed once in every 30 minutes of filtering operation in Example (Paragraph No. 0019) of the invention of Patent Document 2, the present invention makes it possible to obviate air scrubbing, and reduce the number of times when the operation is performed. When the number of times of air scrubbing increases, there is risk that swinging hollow fiber membrane bundles repeatedly come into contact with each other, thereby being damaged. However, in the present invention, it is possible to reduce the number of times of air scrubbing even when it is performed, and therefore damages of membrane as described above are not likely to occur.

When filtering performance has deteriorated as a result of continuing the filtering operation for a long period of time, back-pressure washing is performed. The back-pressure washing is performed by injecting back-pressure washing water, which is added with a medicine as needed, from the permeated water outlet 42 side (possibly from the concentrated water outlet 55). The back-pressure washing discharge water is discharged from the raw water supply port 22 which also serves as the back-pressure washing water outlet through between the hollow fiber membrane bundles 60. Since the first group raw water introduction holes 66 and the second group raw water introduction holes 67 are formed in the first fixed layer 61 as described above, raw water easily flows in an extending direction of longitudinal X-direction of the first group raw water introduction holes 66 and the second group raw water introduction holes 67, and thus drain water of the back-pressure washing is easily discharged.

### EXAMPLES

### Example 1

Filtering operation was performed by using a vertical-type hollow fiber membrane module 1, which was provided with a tubular housing, two caps 20 and 40 on both ends, a first annular holder 30, and a second annular holder 50 as shown in FIG. 1.

Both ends of the hollow fiber membrane bundle were fixed with a urethane-resin based adhesive.

### (Hollow Fiber Membrane Module)

Tubular housing: made of vinyl chloride, outer diameter 17 cm, and inner diameter 13 cm

### (Hollow Fiber Membrane Bundle)

### Cellulose Acetate Hollow Fiber Membrane

Number of hollow fiber membrane bundles: 7 bundles

Outer diameter of hollow fiber membrane bundle: 5 cm

Thickness (t1) of hollow fiber membrane bundle: 2 cm

### (First Fixed Layer 61)

Proportion (A2/A1×100) of a total opening area (A2) of the first group raw water introduction holes 66 and the second group raw water introduction holes 67 in a radial cross sectional area (A1) of the first fixed layer 61: 10.8%

Ratio (A3/A4) of an opening area (A3) of the first group raw water introduction holes 66 and an opening area (A4) of the second group raw water introduction holes 67: 0.54

A driving pump was activated to feed river water in a raw water tank to supply it from the raw water supply port 22 of the hollow fiber membrane module 1, thus starting filtering.

Dead-end filtering operation was performed by supplying raw water in the raw water tank from a raw water supply port 22 via a pump and a raw water line. Concentrated water was not generated because the dead-end filtering operation was adopted. From the permeated water outlet 42, 1.5 L/sec of permeated water was fed to a permeated water tank. Although the filtering operation was continued for 120 hours, no deposit was recognized on the membrane surface, and no fouling occurred either.

Moreover, a cycle of one hour of filtering operation and thereafter, one minute of the back-pressure washing was repeatedly performed. The back-pressure washing was performed by injecting permeated water from the permeated water outlet 42 side. The washing water after the back-pressure washing was discharged from the raw water supply port 22 through a gap between hollow fiber membrane bundles 60.

### INDUSTRIAL APPLICABILITY

The hollow fiber membrane module of the present invention can be used in water purification facilities, sewage processing facilities, seawater desalination facilities, and so on.

### REFERENCE SIGNS LIST

1 Hollow fiber membrane module

10 Tubular housing

20 First-end side cap

21 First a-cap part

22 Raw water supply port (small-diameter part)

23 Large-diameter part

30 Second a-cap part

40 Second-end side cap

41 First b-cap part

50 Second b-cap part

56 Annular space

60 Hollow fiber membrane bundle

65 Raw water introduction hole

66 First group raw water introduction hole

67 Second group raw water introduction hole

1. An external-pressure type hollow fiber membrane module comprising: a tubular housing to which a cap with a liquid access port including a raw water supply port and a cap with a liquid access port including a permeated water outlet are fixed at openings at respective ends; and a plurality of hollow fiber membrane bundles accommodated in the tubular housing, wherein
the plurality of hollow fiber membrane bundles are configured such that
a first end surface thereof on a raw water supply port side is fixed with adhesive, together with an inner wall surface of the tubular housing or an inner wall surface of the cap, in a state in which the hollow fiber membrane bundles on the first end surface side are closed,
a second end surface side thereof on a permeated water outlet side axially opposite to the first end surface side is fixed with adhesive, together with an inner wall surface of the tubular housing or an inner wall surface of the cap, in a state in which the hollow fiber membrane bundles on the second end surface side are open, and
the adhesive-fixed part on the first end surface side includes a plurality of raw water introduction holes formed therethrough in a thickness direction, and wherein
the plurality of raw water introduction holes include:
first group raw water introduction holes formed at positions including central parts of the plurality of hollow fiber membrane bundles, respectively, and second group raw water introduction holes formed between the plurality of hollow fiber membrane bundles and between the plurality of hollow fiber membrane bundles and the inner wall surface of the tubular housing.

2. The external-pressure type hollow fiber membrane module according to claim 1, wherein
the plurality of fiber membrane bundles accommodated in the tubular housing include 3 or more bundles, and
when viewed from the first end surface side, the plurality of fiber membrane bundles are arranged and accommodated in line symmetry with respect to a straight line passing through a center of a radial cross section of the adhesive-fixed part.

3. The external-pressure type hollow fiber membrane module according to claim 1, wherein
the plurality of hollow fiber membrane bundles accommodated in the tubular housing include 4 or more bundles, and
when viewed from the first end surface side, the plurality of hollow fiber membrane bundles are arranged and accommodated in point symmetry with respect to a center of a radial cross section of the adhesive-fixed part.

4. The external-pressure type hollow fiber membrane module according to claim 1, wherein
the plurality of hollow fiber membrane bundles accommodated in the tubular housing include 5 or more bundles,
when viewed from the first end surface side, the plurality of hollow fiber membrane bundles include a central hollow fiber membrane bundle disposed at a center of a radial cross section of the adhesive-fixed part and hollow fiber membrane bundles annularly disposed at equal distances around the central hollow fiber membrane bundle, such that
the plurality of hollow fiber membrane bundles are arranged and accommodated in line symmetry with respect to a straight line passing through the center of the radial cross section of the adhesive-fixed part.

5. The external-pressure type hollow fiber membrane module according to claim 1, wherein
the hollow fiber membrane bundle adjacent to the adhesive-fixed part has an outer diameter of 30 to 70 mm, and a thickness of the hollow fiber membrane bundle (distance from an inner peripheral surface of the first group raw water introduction hole to an outer peripheral surface of the hollow fiber membrane bundle) is 12 to 30 mm.

6. The external-pressure type hollow fiber membrane module according to claim 2, wherein
the hollow fiber membrane bundle adjacent to the adhesive-fixed part has an outer diameter of 30 to 70 mm, and a thickness of the hollow fiber membrane bundle (distance from an inner peripheral surface of the first group raw water introduction hole to an outer peripheral surface of the hollow fiber membrane bundle) is 12 to 30 mm.

7. The external-pressure type hollow fiber membrane module according to claim 3, wherein
the hollow fiber membrane bundle adjacent to the adhesive-fixed part has an outer diameter of 30 to 70 mm, and a thickness of the hollow fiber membrane bundle (distance from an inner peripheral surface of the first group raw water introduction hole to an outer peripheral surface of the hollow fiber membrane bundle) is 12 to 30 mm.

8. The external-pressure type hollow fiber membrane module according to claim 4, wherein
the hollow fiber membrane bundle adjacent to the adhesive-fixed part has an outer diameter of 30 to 70 mm, and a thickness of the hollow fiber membrane bundle (distance from an inner peripheral surface of the first group raw water introduction hole to an outer peripheral surface of the hollow fiber membrane bundle) is 12 to 30 mm.
